(19) United States
(12) Patent Application Publication
(10) Pub. No.: US 2025/0216219 A1
(43) Pub. Date: Jul. 3, 2025

(54) SYSTEMS AND METHODS FOR IMPLEMENTING ANTI-RUTTING DRIVING PATTERNS

(71) Applicant: Torc Robotics, Inc., Blacksburg, VA (US)

(72) Inventors: Joseph R. Fox-Rabinovitz, Blacksburg, VA (US); Nicholas Atanasov, Blacksburg, VA (US); William Davis, Blacksburg, VA (US)

(21) Appl. No.: 18/399,194

(22) Filed: Dec. 28, 2023

(51) Int. Cl. G01C 21/00; B60W 50/00; B60W 60/00

(52) U.S. Cl. CPC G01C 21/3889; B60W 50/00; B60W 60/001; G01C 21/3822; G01C 21/3841; B60W 2050/0028; B60W 2300/12; B60W 2552/35; B60W 2556/40; B60W 2556/65

(57) ABSTRACT

An anti-rutting system is provided. The anti-rutting system includes a processor and a memory. The processor is configured to receive, from one or more autonomous vehicles, sensor data indicating conditions of roads traveled by the one or more autonomous vehicles, generate, based on the sensor data, a model of a surface of the roads traveled by the one or more autonomous vehicles, identify one or more road deterioration features from the model, generate a map indicating locations of the road deterioration features, and transmit the map to the one or more autonomous vehicles, wherein the one or more autonomous vehicles are configured to generate constraints for a planned path of the autonomous vehicle to avoid contact with the locations of the road deterioration features identified in the map while operating.

### TECHNICAL FIELD

The field of the disclosure relates generally to autonomous vehicles and, more specifically, to systems and methods enabling autonomous vehicles to implement anti-rutting driving patterns.

### BACKGROUND OF THE INVENTION

Roads deteriorate over time due to factors such as weather and wear and tear from passing vehicles. Due to their weight, trucks are among of the worst causes of rutting in road surfaces. Ruts are expensive to repair and dangerous. They can cause damage, especially to smaller vehicles, and often require re-paving of entire segments of road to mitigate. These issues may be exacerbated when trucks repeatedly pass over a rutted location of a road. A systematic method for preventing and avoiding road ruts in high-traffic areas is therefore desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an anti-rutting system is provided. The anti-rutting system includes a processor and a memory. The processor is configured to receive, from one or more autonomous vehicles, sensor data indicating conditions of roads traveled by the one or more autonomous vehicles, generate, based on the sensor data, a model of a surface of the roads traveled by the one or more autonomous vehicles, identify one or more road deterioration features from the model, generate a map indicating locations of the road deterioration features, and transmit the map to the one or more autonomous vehicles, wherein the one or more autonomous vehicles are configured to generate constraints for a planned path of the autonomous vehicle to avoid contact with the locations of the road deterioration features identified in the map while operating.

In another aspect, an anti-rutting method is provided. The anti-rutting method includes receiving, from one or more autonomous vehicles, sensor data indicating conditions of roads traveled by the one or more autonomous vehicles, generating, based on the sensor data, a model of a surface of the roads traveled by the one or more autonomous vehicles, identifying one or more road deterioration features from the model, generating a map indicating locations of the road deterioration features; and transmitting the map to the one or more autonomous vehicles, wherein the one or more autonomous vehicles are configured to generate constraints for a planned path of the autonomous vehicle to avoid contact with the locations of the road deterioration features identified in the map while operating.

In yet another aspect, an anti-rutting system is provided. The anti-rutting system includes one or more autonomous vehicles and a server processor in communication with the one or more autonomous vehicles. The server processor is configured to receive, from the one or more autonomous vehicles, sensor data indicating conditions of roads traveled by the one or more autonomous vehicles, generate, based on the sensor data, a model of a surface of the roads traveled by the one or more autonomous vehicles, identify one or more road deterioration features from the model, generate a map indicating locations of the road deterioration features, and transmit the map to the one or more autonomous vehicles, wherein the one or more autonomous vehicles are configured to generate constraints for a planned path of the autonomous vehicle to avoid contact with the locations of the road deterioration features identified in the map while operating.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts an example autonomous vehicle;

FIG. 2 is a block diagram illustrating components of the autonomous vehicle shown in FIG. 1;

FIG. 3 is a diagram of an anti-rutting system including the autonomous vehicle shown in FIGS. 1 and 2; and

FIG. 4 is a flow chart of an anti-rutting method performed using the anti-rutting system shown in FIG. 3.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The embodiments described herein include a system for reducing road rutting and other road damage by controlling a one or more autonomous vehicles to collect data used identify ruts or other damage to roads (referred to herein as “road deterioration features”), generate a map of the identified road deterioration features, and provide the map to the autonomous vehicles so that during operation, the autonomous vehicles avoid driving over the identified road deterioration features, which reduces a chance of exacerbating the road deterioration features and causing damage to the autonomous vehicles. For example, if a rut is identified in a road, the autonomous vehicles plan a path having constraints to avoid running wheels through the ruts, which reduces the chance of deepening the ruts.

In an example embodiment, the system includes a processor and a memory. The processor is configured to receive, from one or more autonomous vehicles, sensor data indicating conditions of roads traveled by the one or more autonomous vehicles. The processor is further configured to generate, based on the sensor data, a model of a surface of the roads traveled by the one or more autonomous vehicles, from which the processor is configured to identify one or more road deterioration features of the analyzed road. The processor is further configured to generate a map indicating locations of the road deterioration features and any other relevant data and transmit the map to the autonomous vehicles. When the autonomous vehicles receive the map, the autonomous vehicles are configured to avoid contact with the locations of the road deterioration features identified in the map while operating. For example, if one of the road deterioration features is a rut, one of the autonomous vehicles may adjust its lateral path while traversing a road portion that includes the rut to avoid having its wheels travel through the rut.

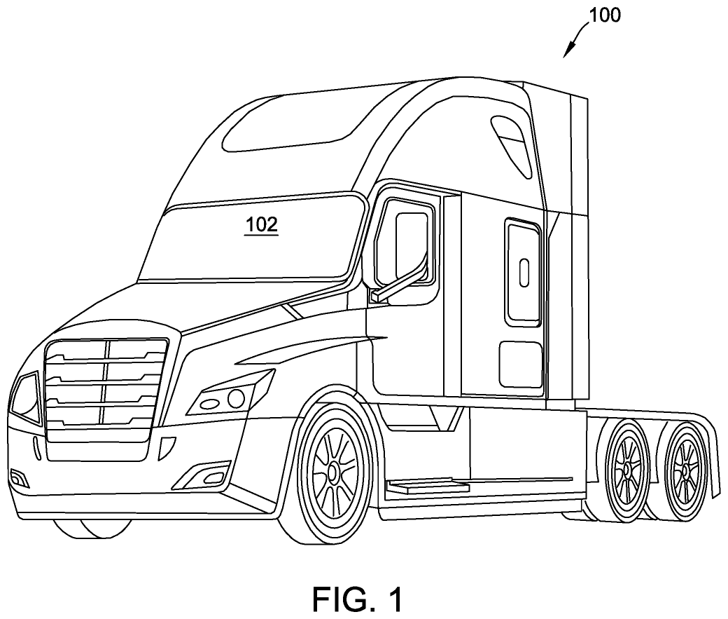

FIG. 1 is a diagram of an example embodiment of an autonomous vehicle 100. An autonomous vehicle 100 may have a driver or a passenger in a cab 102 of the autonomous vehicle 100. In certain embodiments, these vehicle occupants may take control of the vehicle and drive it manually. In alternative embodiments, in which a driver is not required, cab 102 may be omitted.

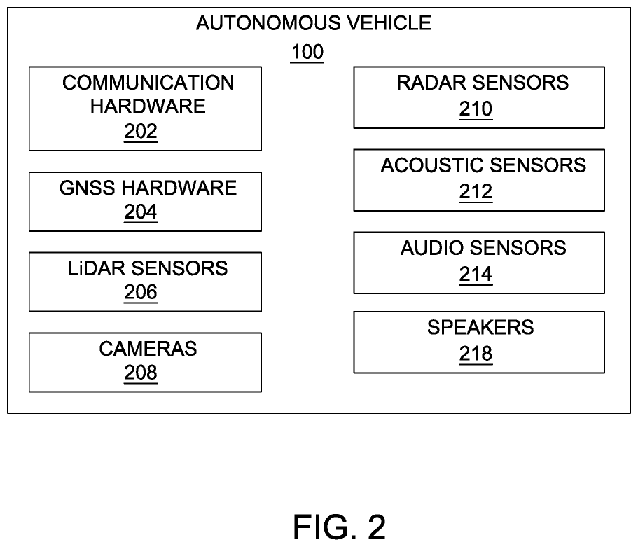

FIG. 2 is a block diagram of autonomous vehicle 100. As shown in FIG. 2, autonomous vehicle 100 includes various components for assisting autonomous operation such as, for example, communications hardware 202 (e.g., antennas, radio transmitters and receivers, or other associated circuitry), global navigation satellite system (GNSS) receivers 204 (e.g., antennas capable of receiving location, timing and velocity information from Global Positioning System (GPS) or other navigation satellite constellations), light detection and ranging (LiDAR) sensors 206, cameras 208, radio detection and ranging (RADAR) sensors 210, acoustic sensors 212 (e.g., ultrasound or sound navigation and ranging (SONAR) sensors), microphones or other audio sensors 214, and speakers 218.

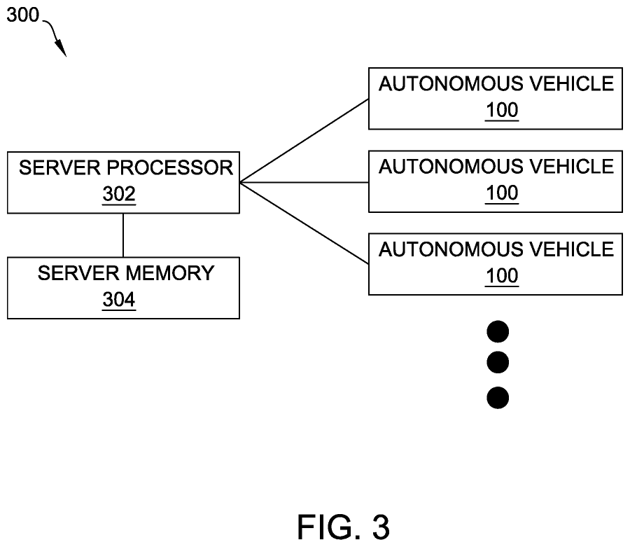

FIG. 3 is a block diagram of an example anti-rutting system 300. In the example embodiment, anti-rutting system 300 includes a server processor 302, a server memory 304, and one or more autonomous vehicles 100. In some embodiments, server processor 302 is disposed remotely from one or more of autonomous vehicles 100, and autonomous vehicles 100 are configured to communicate wirelessly with server processor 302 using communications hardware 202 (e.g., through cellular or another type of wireless communication). Alternatively, server processor 302 may be incorporated into one or more of autonomous vehicles 100 or some of the functionality described herein with respect to server processor may be performed by autonomous vehicles 100. In the example embodiment, computer-executable instructions are stored in server memory 304, which can be executed by server processor 302 to perform the functions described herein.

In the example embodiment, server processor 302 is configured to receive, from autonomous vehicles 100, sensor data indicating conditions of roads traveled by autonomous vehicles 100. In particular, these conditions include a shape of the road surface. The sensor data may be generated by any of the sensors of autonomous vehicle 100 described above with respect to FIGS. 1 and 2. In some embodiments, at least some of the sensor data is generated by LiDAR sensors 206, such as ground-facing LiDAR sensors 206 or other LiDAR sensors 206 capable of detecting the road (e.g., front-facing or rear-facing sensors). In some embodiments, at least some of the sensor data is generated by RADAR sensors 210 (e.g., ground-facing, front-facing, side-facing, or rear-facing RADAR sensors 210). In some such embodiments, RADAR sensors 210 include ground-penetrating RADAR (GPR) sensors capable of detecting properties beneath the surface of the road. In some embodiments, at least some of the sensor data is generated by cameras 208 (e.g., ground-facing, front-facing, side-facing, or rear-facing cameras 208). For example, single cameras can determine surface type and detect areas of discoloration, and stereo cameras can detect road depth relative to some reference surface. In some embodiments, in addition to measuring road depth, LiDAR sensors 206 or cameras 208 can be used to measure deviation of road markings, which is correlated to lateral distortion of the road.

In the example embodiment, server processor 302 is configured to generate, based on the sensor data, a model of a surface of the roads traveled by autonomous vehicles 100. In some embodiments, the model includes multiple dimensions, of which some may correspond to the spatial dimensions of the road surface. In other embodiments, three of the model dimensions may correspond to the spatial dimensions of the road surface and depth. In some embodiments, the model may have more abstract dimensions for other quantities of interest such as color, apparent surface strength or integrity, material of composition, and others. In some embodiments, the model is generated based on cumulative sensor data from many different trips of autonomous vehicles 100 and periodically or continuously updated. In some embodiments, the model includes a plurality (e.g., a matrix or array) of road depth values. The road depth values may be defined as a difference between a measured road depth value and a reference value (e.g., a nominal distance between the sensor and the surface of the road). The road depth values are captured at, for example, regular longitudinal and lateral intervals across the road surface, with a greater number of depth value measurements per unit area enabling for a higher resolution model of the road surface to be generated. In some embodiments, the generated models are stored at server memory 304

In the example embodiment, server processor 302 is configured to identify one or more road deterioration features from the model. The road deterioration features include ruts, and may also include other features such as cracks, potholes, protruding drains or pipes, distortion, stretching, or buckling of the road surface, other such features. In some embodiments, to identify the one or more road deterioration features, server processor 302 is configured to compare at least one of the plurality of road depth values to a reference value. For example, server processor 302 may determine if any of the road depth values differs from a nominal road depth value by a threshold amount and identify areas of the model including these road depth values as corresponding to a road deterioration feature. In some embodiments, to identify the one or more road deterioration features, server processor 302 is configured to apply an identification model configured to identify the one or more road deterioration features based on an input of the model. In some embodiments, the identification model is a machine learning model trained using labeled or unlabeled sensor data, images, portions of road models, or arrays of depth values associated with one or more types of road deterioration features. Such a machine learning model may be periodically or continually retrained or enhanced as new sensor data, images, portions of road models, or arrays of depth values are received or generated by server processor 302.

In the example embodiment, server processor 302 is configured to generate a map indicating locations of the road deterioration features. In some embodiments, the map is periodically or continuously updated as the underlying model is updated. The generated map, when processed by autonomous vehicles 100, enables autonomous vehicles 100 to determine relative locations of the road deterioration features with respect to autonomous vehicles 100. Accordingly, the generated map can be but does not necessarily need to be visually interpretable by humans. In some embodiments, the map further includes information relating to one or more of road materials, rut depths, road sub-surface conditions, or lateral road distortion. In some embodiments, server processor 302 utilizes data in addition to the model and determined locations of road deterioration features to generate the map. This data may include preexisting mapping data (e.g., locations of and other data relating to roads), some of which may be stored locally in server memory 304 or available over the Internet. In embodiments in which the generated map is visually interpretable by humans or can be converted to a form that is visually interpretable by humans, the map can be provided to government bodies or other organizations responsible for taking care of roads so that any issues identified with the roads may be addressed. In some embodiments, the generated map is stored at server memory 304.

In the example embodiment, server processor 302 is configured to transmit the map to autonomous vehicles 100. Autonomous vehicles 100 are configured to adjust their operation based on the received map, for example, to reduce or avoid contact with the locations of the road deterioration features identified in the map while operating. In some embodiments, autonomous vehicles 100 are configured to apply a routing model that determines constraints to a path of the autonomous vehicle based on the locations of the road deterioration features. A constraint is a cost for deviating from or encroaching on a particular area. The path planner must minimize the total cost imposed by all the constraints, including the ones generated by the routing model. In some such embodiments, the routing model is a machine learning module trained to output the constraints based on an input of the map. This model may be trained to determine the desirability of the different parts of the road based on the locations of road deterioration features and other factors such as road type/material, existing rut height, sub-surface condition, and any other available criteria. In such embodiments, autonomous vehicles 100 are configured to utilize data output from the model (e.g., lateral path constraints) as part of their planning and resulting vehicle control operations to reduce or avoid contact the locations of the road deterioration features, thereby reducing a chance of damaging autonomous vehicles 100 or exacerbating existing road deterioration features. For example, utilizing the generated map, autonomous vehicles 100 can avoid driving in existing ruts, thereby reducing the chance of autonomous vehicles 100 deepening the ruts or damaging autonomous vehicle 100. This also potentially enables autonomous vehicles 100 to mitigate the damage caused by other truck fleets.

In some embodiments, server processor 302 may further a compile a map of all the recently-used paths by a given fleet autonomous vehicles 100, based on which autonomous vehicles 100 can identify less-used portions of the road. A path for any given autonomous vehicle 100 can then be chosen to maximize usage of less-used portions of the road, thereby reducing the chance of developing or deepening ruts.

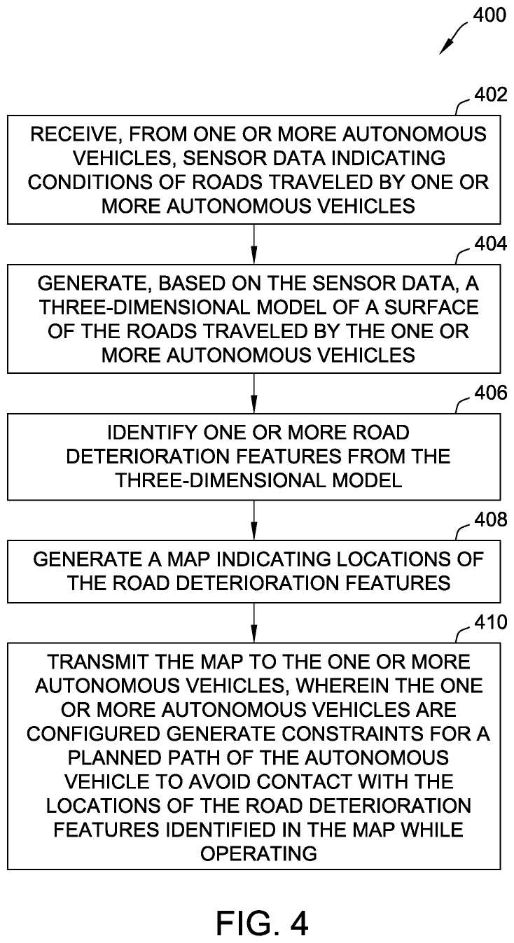

FIG. 4 is a flow chart depicting an example anti-rutting method 400. In the example embodiment, anti-rutting method 400 method is performed by anti-rutting system 300 (shown in FIG. 3).

In the example embodiment server processor 302 receives 402, from one or more autonomous vehicles 100, sensor data indicating conditions of roads traveled by autonomous vehicles 100.

In the example embodiment, server processor 302 generates 404, based on the sensor data, a model of a surface of the roads traveled by autonomous vehicles 100.

In the example embodiment, server processor 302 identifies 406 one or more road deterioration features from the model.

In the example embodiment, server processor 302 generates 408 a map indicating locations of the road deterioration features.

In the example embodiment, server processor 302 transmits 410 the map to autonomous vehicles 100, wherein autonomous vehicles 100 are configured to generate constraints for a planned path of autonomous vehicle 100 to avoid contact with the locations of the road deterioration features identified in the map while operating.

In some embodiments, at least some of the sensor data is generated by one or more of ground-facing LiDAR sensors, GPR sensors, acoustic sensors, or cameras of autonomous vehicles 100.

In some embodiments, to identify the one or more road deterioration features, server processor 302 compares at least one of the plurality of road depth values to a reference value.

In some embodiments, to identify the one or more road deterioration features, server processor 302 applies an identification model configured to identify the one or more road deterioration features based on an input of the model.

In some embodiments, at least one of the one or more road deterioration features is a rut.

In some embodiments, autonomous vehicles 100 are configured to apply a routing model that determines the constraints to the planned path of the autonomous vehicle based on the locations of the road deterioration features. In some such embodiments, the routing model is a machine learning module trained to output the constraints based on an input of the map.

In some embodiments, the map further includes information relating to one or more of road materials, rut depths, road sub-surface conditions, or lateral road distortion.

An example technical effect of the methods, systems, and apparatus described herein includes at least one of: (a) reducing road damage and rutting caused by trucks by generating a map of locations of road deterioration features and controlling autonomous vehicles to avoid contact with the road deterioration features, (b) reducing damage to vehicles caused by road damage and rutting by generating a map of locations of road deterioration features and controlling autonomous vehicles to avoid contact with the road deterioration features, (c) generating a map of locations of road deterioration features by generating a model using sensor data collected from vehicles and analyzing the three dimensional model to identify the road deterioration features, and (d) generating a map of road deterioration features using sensor data collected from vehicles that is sharable with interested parties.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An anti-rutting system comprising a processor and a memory, the processor configured to:
receive, from one or more autonomous vehicles, sensor data indicating conditions of roads traveled by the one or more autonomous vehicles;
generate, based on the sensor data, a model of a surface of the roads traveled by the one or more autonomous vehicles;
identify one or more road deterioration features from the model;
generate a map indicating locations of the road deterioration features; and
transmit the map to the one or more autonomous vehicles, wherein the one or more autonomous vehicles are configured to generate constraints for a planned path of the autonomous vehicle to avoid contact with the locations of the road deterioration features identified in the map while operating.

2. The anti-rutting system of claim 1, wherein at least some of the sensor data is generated by one or more of ground-facing LiDAR sensors, ground-penetrating RADAR sensors, acoustic sensors, or cameras of the one or more autonomous vehicles.

3. The anti-rutting system of claim 1, wherein the model includes a plurality of road depth values, and wherein to identify the one or more road deterioration features, the processor is configured to compare at least one of the plurality of road depth values to a reference value.

4. The anti-rutting system of claim 1, wherein to identify the one or more road deterioration features, the processor is configured to apply an identification model configured to identify the one or more road deterioration features based on an input of the model.

5. The anti-rutting system of claim 1, wherein at least one of the one or more road deterioration features is a rut.

6. The anti-rutting system of claim 1, wherein the one or more autonomous vehicles are configured to apply a routing model that determines the constraints to the planned path of the autonomous vehicle based on the locations of the road deterioration features.

7. The anti-rutting system of claim 6, wherein the routing model is a machine learning module trained to output the constraints based on an input of the map.

8. The anti-rutting system of claim 1, wherein the map further includes information relating to one or more of road materials, rut depths, road sub-surface conditions, or lateral road distortion.

9. An anti-rutting method comprising:
receiving, from one or more autonomous vehicles, sensor data indicating conditions of roads traveled by the one or more autonomous vehicles;
generating, based on the sensor data, a model of a surface of the roads traveled by the one or more autonomous vehicles;
identifying one or more road deterioration features from the model;
generating a map indicating locations of the road deterioration features; and
transmitting the map to the one or more autonomous vehicles, wherein the one or more autonomous vehicles are configured to generate constraints for a planned path of the autonomous vehicle to avoid contact with the locations of the road deterioration features identified in the map while operating.

10. The anti-rutting method of claim 9, wherein at least some of the sensor data is generated by one or more of ground-facing LiDAR sensors, ground-penetrating RADAR sensors, acoustic sensors, or cameras of the one or more autonomous vehicles.

11. The anti-rutting method of claim 9, wherein the model includes a plurality of road depth values, and wherein identifying the one or more road deterioration features comprises comparing at least one of the plurality of road depth values to a reference value.

12. The anti-rutting method of claim 9, wherein identifying the one or more road deterioration features comprises applying an identification model configured to identify the one or more road deterioration features based on an input of the model.

13. The anti-rutting method of claim 9, wherein at least one of the one or more road deterioration features is a rut.

14. The anti-rutting method of claim 9, wherein the one or more autonomous vehicles are configured to apply a routing model that determines the constraints to the planned path of the autonomous vehicle based on the locations of the road deterioration features.

15. The anti-rutting method of claim 14, wherein the routing model is a machine learning module trained to output the constraints based on an input of the map.

16. The anti-rutting method of claim 9, wherein the map further includes information relating to one or more of road materials, rut depths, road sub-surface conditions, or lateral road distortion.

17. An anti-rutting system comprising:
one or more autonomous vehicles; and
a server processor in communication with the one or more autonomous vehicles, the server processor configured to:
receive, from the one or more autonomous vehicles, sensor data indicating conditions of roads traveled by the one or more autonomous vehicles;
generate, based on the sensor data, a model of a surface of the roads traveled by the one or more autonomous vehicles;
identify one or more road deterioration features from the model;
generate a map indicating locations of the road deterioration features; and
transmit the map to the one or more autonomous vehicles, wherein the one or more autonomous vehicles are configured to generate constraints for a planned path of the autonomous vehicle to avoid contact with the locations of the road deterioration features identified in the map while operating.

18. The anti-rutting system of claim 17, wherein at least some of the sensor data is generated by one or more of ground-facing LiDAR sensors, ground-penetrating RADAR sensors, acoustic sensors, or cameras of the one or more autonomous vehicles.

19. The anti-rutting system of claim 17, wherein the model includes a plurality of road depth values, and wherein to identify the one or more road deterioration features, the server processor is configured to compare at least one of the plurality of road depth values to a reference value.

20. The anti-rutting system of claim 17, wherein to identify the one or more road deterioration features, the server processor is configured to apply an identification model configured to identify the one or more road deterioration features based on an input of the model.
